(19) United States
(12) Patent Application Publication
(10) Pub. No.: US 2013/0140982 A1
(43) Pub. Date: Jun. 6, 2013

(54) ORGANIC LIGHT EMITTING DISPLAY DEVICE AND MANUFACTURING METHOD THEREOF

(71) Applicant: Soon-Ryong PARK, Cheonan-si (KR)

(72) Inventor: Soon-Ryong PARK, Cheonan-si (KR)

(21) Appl. No.: 13/466,306

(22) Filed: May 8, 2012

(30) Foreign Application Priority Data
Dec. 1, 2011 (KR) 10-2011-0127394

(51) Int. Cl. H01J 1/70; B32B 37/12; B32B 38/00

(52) U.S. Cl. 313/504; 156/278; 156/182

(57) ABSTRACT

An organic light-emitting display device includes a substrate, a first electrode on the substrate, an organic layer on the first electrode, the organic layer including a light-emitting layer, a second electrode on an opposite side of the organic layer from the first electrode, a protective layer on the second electrode, a window member spaced apart from the protective layer, wherein the first electrode, the organic layer, the second electrode, and the protective layer are between the window member and the substrate, and a bead coating layer between the protective layer and the window member.

### BACKGROUND

1. Field

Embodiments relate to an organic light-emitting display device and a method of manufacturing the same, and more particularly to an organic light-emitting display device, which has enhanced luminous efficiency and visibility, and a method of manufacturing the same.

2. Description of the Related Art

An organic light-emitting diode display device is a self emitting display device that displays an image by using organic light-emitting diodes. The organic light-emitting diode display device does not need a separate light source, unlike a liquid crystal display device, and thus, may have a smaller thickness and weight. Such an organic light-emitting diode display device exhibits excellent characteristics, such as low power consumption, high brightness, high response speed, etc., and is attracting attention as a next-generation display device for portable electronic appliances.

In general, an organic light-emitting diode includes a hole injection electrode, organic light-emitting layer and electron injection electrode. Light emission by the organic light-emitting diode takes place using energy generated when excitons, which are formed as holes from the hole injection electrode and electrons from the electron injection electrode recombine in the organic light-emitting layer, fall to the ground state.

### SUMMARY

According to an embodiment, there is provided an organic light-emitting display device including a substrate, a first electrode on the substrate, an organic layer on the first electrode, the organic layer including a light-emitting layer, a second electrode on an opposite side of the organic layer from the first electrode, a protective layer on the second electrode, a window member spaced apart from the protective layer such that the first electrode, the organic layer, the second electrode, and the protective layer are between the window member and the substrate, and a bead coating layer between the protective layer and the window member. The bead coating layer may be on a surface of the protective layer facing the window member, at a distance from the window member. The bead coating layer may be located on a surface of the window member facing the protective layer, at a distance from the protective layer. The window member may be glass. The window member and the substrate may be sealed by a seal.

The bead coating layer may include bead particles distributed in an organic matrix. A content of bead particles may be in a range of 50 to 80 wt % based on a total weight of the bead coating layer. A content of the matrix may be in a range of 20 to 50 wt % based on a total weight of the bead coating layer. A thickness of the bead coating layer may be in a range of 10 μm to 30 μm. An average diameter of the bead particles may be in a range of 100 nm to 5 μm. The bead particles may be selected from silica-based particles, zirconium-based particles and zirconium oxide particles.

According to an embodiment, there is provided a method of manufacturing an organic light-emitting display device, the method including forming a first electrode on a substrate, forming an organic layer including a light-emitting layer on the first electrode, forming a second electrode on the organic layer, forming a protective layer on the second electrode, forming a bead coating layer on the top of the protective layer, and providing a window member such that the first electrode, the organic layer, the second electrode, and the protective layer are between the window member and the substrate

According to an embodiment, there is provided a method of manufacturing an organic light-emitting display device. The method includes forming a first electrode on a substrate, forming an organic layer including a light-emitting layer on the first electrode, forming a second electrode on the organic layer, forming a protective layer on the second electrode, forming a bead coating layer on a surface of a window member, and arranging the window member such that the first electrode, the organic layer, the second electrode, and the protective layer are between the window member and the substrate and such that the surface of the window member on which the bead coating layer is formed faces the protective layer, and sealing the window member.

In the above methods, the window member may be glass. The window member and the substrate may be sealed to each other by a seal formed along an edge of the window member. The bead coating layer may include bead particles distributed in an organic matrix. A content of bead particles may be in a range of 50 to 80 wt % based on a total weight of the bead coating layer. A content of the matrix may be in a range of 20 to 50 wt % based on a total weight of the bead coating layer. A thickness of the bead coating layer may be in a range of 10 μm to 30 μm. The bead coating layer may be formed by applying and hardening a polymer syrup containing the bead particles. The polymer syrup containing the bead particles may include a light curable polymer and the bead particles. The light curable polymer may be an acryl-based polymer resin. An average diameter of the bead particles may be in a range of 100 nm to 5 μm. The bead particles are selected from silica-based particles, zirconium-based particles and zirconium oxide particles.

### BRIEF DESCRIPTION OF THE DRAWINGS

Features will be apparent from the following detailed description taken in conjunction with the accompanying drawings, in which:

FIG. 1 is a sectional view schematically illustrating an organic light-emitting display device according to an embodiment;

FIG. 2 is a sectional view schematically illustrating an organic light-emitting display device according to another embodiment;

FIGS. 3A to 3C are images showing light emission depending on a distance between a protective layer and a bead coating layer;

FIG. 4 is a view illustrating light paths changed under provision of the bead coating layer;

FIG. 5 is a graph illustrating light-extraction efficiency depending on the content of bead particles in the bead coating layer; and

FIG. 6 is a graph illustrating probability of color difference depending on the content of bead particles in the bead coating layer.

### DETAILED DESCRIPTION

This application claims the benefit of Korean Patent Application No. 10-2011-0127394, filed on Dec. 1, 2011, in the Korean Intellectual Property Office and entitled “ORGANIC LIGHT EMITTING DISPLAY DEVICE AND MANUFACTURING METHOD THEREOF,” the disclosure of which is incorporated herein in its entirety by reference.

Hereinafter, embodiments will be described in detail with reference to the accompanying drawings.

While the embodiments are susceptible to various modifications and alternative forms, specific embodiments thereof are shown by way of example in the drawings and will herein be described in detail. It should be understood, however, that there is no intent to be limiting with respect to the particular forms disclosed, but on the contrary, it is intended that all modifications, equivalents, and alternatives falling within the spirit and scope thereof be covered, as defined by the claims.

So long as being not specially defined, all terms in the context of describing the embodiments may be commonly understood by those skilled in the art to have the same meaning as the general meaning, or may be dedicatedly defined in the specification when having a specific meaning conflicting with the general meaning thereof.

In the following description, a detailed description of known functions and configurations incorporated herein will be omitted when it may make the subject matter rather unclear. In the drawings, the same or similar elements are denoted by the same reference numerals even though they are depicted in different drawings, and the thickness or size of each constituent element may be schematically illustrated for clarity and convenience. Thus, the embodiments are not essentially limited to the disclosure of the drawings.

In the drawings, thicknesses of several layers and regions are exaggerated for clarity of description. It will be understood that, when an element such as a layer, film, region or substrate is referred to as being “on” another element, it can be directly on the other element or intervening elements may also be present.

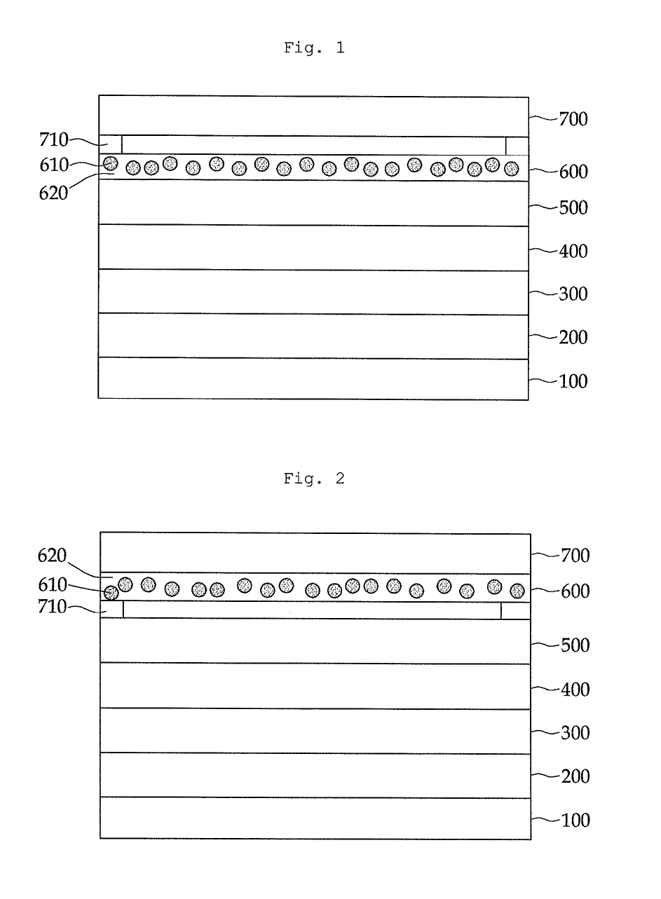

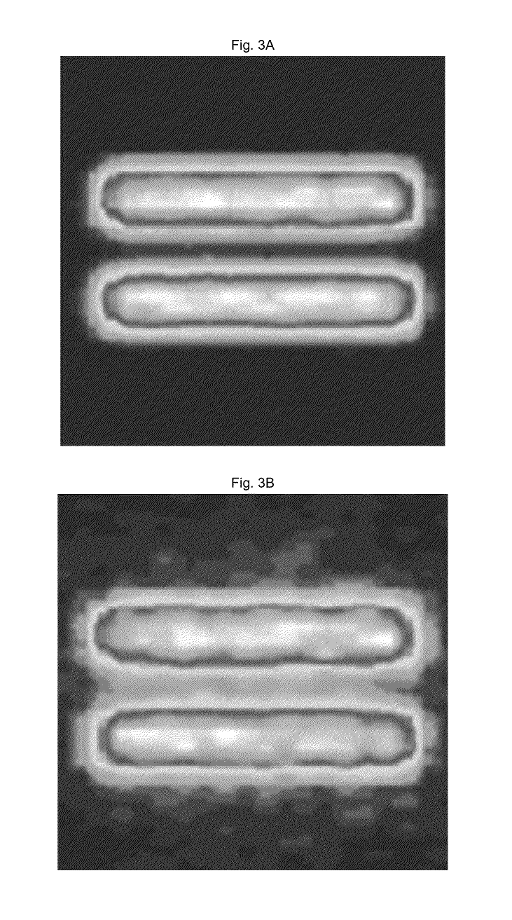

Hereinafter, embodiments will be described with reference to FIGS. 1 and 2.

FIG. 1 is a sectional view schematically illustrating an organic light-emitting display device according to an embodiment.

As illustrated in FIG. 1, the organic light-emitting display device according to an exemplary embodiment includes a first electrode 200 placed on an upper surface of a substrate 100. The first electrode 200 may be either an anode or a cathode. In the present embodiment, the first electrode 200 is an anode.

The substrate 100 may be a glass substrate, plastic substrate, metal foil, or the like. Assuming that a conductive substrate, such as a metal foil, is used, an insulating film is formed on an upper surface of the conductive substrate for electrical insulation. In the present embodiment, use of a glass substrate will be described by way of example.

Although not illustrated in the drawings, a pixel circuit including thin film transistors may be provided between the substrate 100 and the first electrode 200.

The first electrode 200 is not limited to the configuration illustrated in FIG. 1. The first electrode may be formed of a transparent conductive oxide (TCO). The TCO may be indium tin oxide (ITO), indium zirconium oxide (IZO), indium oxide (In₂O₃), or the like. Although the first electrode of the present embodiment may be a reflective electrode, in this case, the first electrode may be a stack of a TCO on a metal layer.

A second electrode 400 is provided at a position opposite to the first electrode 200.

The second electrode 400 may be a cathode. The second electrode may be formed of alloys or stacks of highly conductive metals having a low work-function absolute value, such as Ag, Mg, Al, Pt, Au, Ni, Nd, Ir, Cr, Li, Ca or the like. In the present embodiment, the second electrode 400 is a transparent electrode. The transparent electrode may be a stack of a TCO and metal. If the second electrode 400 is a transparent cathode, an electron transport layer may be formed on the bottom of the second electrode 400 to improve electron transport capabilities.

An organic layer 300 is interposed between the first electrode 200 and the second electrode 400.

The organic layer 300 may take the form of a multilayer film including one or more of a light-emitting layer, hole injection layer, hole transport layer, electron transport layer and electron injection layer. Among the aforementioned layers, the remaining layers except for the light-emitting layer may be omitted as desired. If the organic layer 300 includes all of the aforementioned layers, the hole injection layer is placed on the first electrode 200 serving as an anode, and the hole transport layer, light-emitting layer, electron transport layer and electron injection layer are sequentially stacked thereon. The organic layer 300 may further include other layers as desired.

A protective layer 500 is formed on the top of the second electrode 400.

The protective layer is also called a capping layer (CPL). The protective layer 500 functions to protect the organic layer 300 from moisture, air and the like. The protective layer 500 may contain an ultraviolet-blocking material. The ultraviolet-blocking material may include zinc oxide (ZnO), titanium oxide (TiO₂), iron oxide (FeO), magnesium oxide (MgO) and the like. Providing the protective layer 500 with the ultraviolet-blocking material allows ultraviolet light directed from the outside to be absorbed by the protective layer 500, which restricts the transmission of ultraviolet light to the organic layer 300. The ultraviolet-blocking function of the protective layer 500 may extend the lifespan of the organic layer 300 that is protected by the protective layer 500.

The protective layer 500 may be formed of an amorphous organic film or amorphous inorganic film. More specifically, the protective layer 500 may be formed of an amorphous inorganic film fabricated by depositing one or more of a-NPD, NPB, TPD, m-MYDATA, Alq₃, LiF and CuPc and the above-described ultraviolet-blocking material in the unit of atoms or molecules. The amorphous protective layer 500 may maintain transparency. That is to say, the amorphous protective layer 500 may allow light emitted from the organic layer 300 to be directed to the outside through the protective layer 500 without considerable loss, enabling formation of an image.

If the protective layer 500 is formed of an amorphous organic film or amorphous inorganic film, molecules or atoms included in the protective layer 500 may have a dense configuration. The protective layer 500 having a dense configuration acts to completely prevent moisture from entering the organic layer 300 from the outside.

Providing the organic light-emitting display device according to the exemplary embodiment with the protective layer 500 containing the ultraviolet-blocking material has the effect of restricting damage to the organic layer due to ultraviolet light and moisture, extending the lifespan of the organic light-emitting display device.

A window member 700 is spaced apart from the protective layer 500 with a predetermined space therebetween. The window member 700 is formed of a transparent material, such as glass, plastics and the like. The window member 700 and the substrate 100 may be sealed to each other by a seal 710 provided along an edge thereof. The seal 710 may be located directly between a peripheral edge of the window 700 and the substrate 100.

A bead coating layer 600 is located between the protective layer 500 and the window member 700.

In the embodiment illustrated in FIG. 1, the bead coating layer 600 is located on the top of the protective layer 500, at a surface of the protective layer 500 facing the window member 700 and at a distance from the window member 700.

The bead coating layer 600 is configured in such a way that bead particles 610 are distributed in a matrix 620 formed of a transparent material. By way of example, the thickness of the bead coating layer may be in the range of 10˜30 μm.

The bead coating layer 600, for example, may be formed by applying and hardening a polymer syrup containing the bead particles 610 onto the protective layer 500. In some embodiments, the bead coating layer 600 may be prefabricated in the form of a stackable film. More specifically, the polymer syrup containing the bead particles 610 includes a light curable polymer and the bead particles 610. One example of the light curable polymer may be an acrylate. In this case, the transparent material of the matrix is an acryl-based polymer resin.

The content of the bead particles 610 may be in the range of 50˜80 wt % based on the total weight of the bead coating layer 600. A content of the bead particles 610 less than 50 wt % may cause weak luminous efficiency, whereas a content of the bead particles greater than 80 wt % may make it difficult to form the bead coating layer.

The average diameter of the bead particles 610 is in the range of 100 nm to 5 μm. A diameter of the bead particles less than 100 nm may cause a weak luminous efficiency, whereas a diameter of the bead particles greater than 5 μm may carry a risk that the particles are observable from the outside and also has a negative effect on the luminous efficiency.

Examples of the bead particles 610 include silica-based particles, zirconium-based particles, zirconium oxide (ZrOₓ) particles or the like.

The content of the matrix 620 is in the range of 20˜50 wt % based on the total weight of the bead coating layer 600, and a constituent material of the matrix 620 is selectable without limitation so long as it is transparent. The matrix 620 may be formed of a transparent polymer resin in consideration of ease of formation of the coating layer. The transparent polymer resin may be fabricated by hardening an uncured transparent polymer containing a photo-initiator and cross-linking agent.

As described above, providing the organic light-emitting display device according to the embodiment with the bead coating layer 600 has the effects of preventing light loss due to total reflection and reducing color difference due to a difference in light paths, resulting in enhanced luminous efficiency and visibility of the organic light-emitting display device.

Hereinafter, an organic light-emitting display device according to another embodiment will be described with reference to FIG. 2.

As illustrated in FIG. 2, the organic light-emitting display device according to another embodiment includes the substrate 100, first electrode 200, organic layer 300, second electrode 400, protective layer 500, bead coating layer 600 and window member 700.

Unlike the previous embodiment illustrated in FIG. 1, in the present embodiment illustrated in FIG. 2, the bead coating layer 600 is located on the bottom of the window member 700, facing the protective layer 500 and at a distance from the protective layer 500.

To obtain the above-described configuration, after the bead coating layer 600 is formed on the bottom of the window member 700, the window member 700, which has been integrated with the bead coating layer 600, may be hermetically bonded to the protective layer 500. Then the window member 700 and the substrate 100 can be sealed to each other by a seal provided along an edge thereof. In this case, the bead coating layer 600, for example, may be formed by applying and hardening a polymer syrup containing the bead particles 610 onto the bottom of the window member 700. In some embodiments, the bead coating layer 600 may be prefabricated in the form of a stackable film.

Other aspects of the embodiment of FIG. 2, other than the bead coating layer 600 being formed on the bottom of the window member 700, are substantially identical to the description of the embodiment illustrated in FIG. 1.

Likewise, through provision of the bead coating layer 600, the organic light-emitting diode display device according to the present embodiment can achieve enhanced luminous efficiency and visibility.

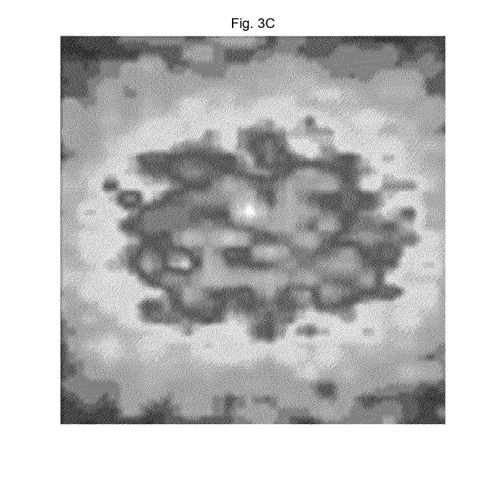

FIGS. 3A to 3C are images showing light emission depending on a distance between the protective layer 500 and the bead coating layer 600 under the assumption of provision of the bead coating layer 600. Specifically, FIGS. 3A to 3C illustrate light emission in the cases in which the distance between the protective layer 500 and the coating layer 600 is 0 μm, 50 μm, and 500 μm, respectively.

Referring to these drawings, light emission is clearer as the distance between the protective layer 500 and the bead coating layer 600 decreases, and light emission is less clear as the distance between the protective layer 500 and the bead coating layer 600 increases.

If the bead coating layer 600 were to be formed on the top of the window member 700, the distance between the protective layer 500 and the bead coating layer 600 may excessively increase, causing a screen to appear foggy. Therefore, in the present embodiments the bead coating layer 600 is formed between the protective layer 500 and the window member 700, i.e. on the top of the protective layer 500 facing the window member 700 or on the bottom of the window member 700 facing the protective layer.

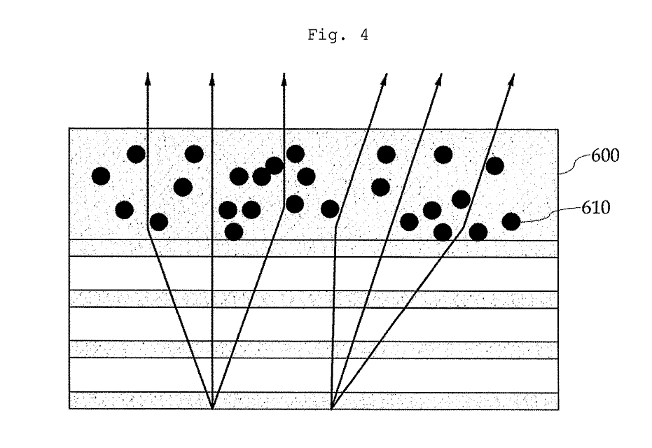

FIG. 4 is a view illustrating light paths changed by the bead particles 610 under the assumption of provision of the bead coating layer 600 according to the embodiment.

According to the embodiment, the bead coating layer 600 serves to guide incident light forward when viewed from the front and also, to guide incident light laterally when viewed from the side. In this way, the bead coating layer 600 has the effect of reducing color difference (White Angular Dependence (WAD)) depending on viewing angle via mixing of light to be directed in all directions.

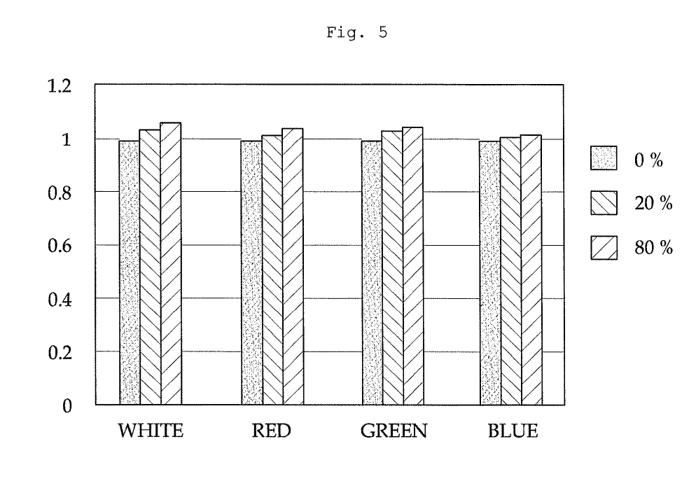

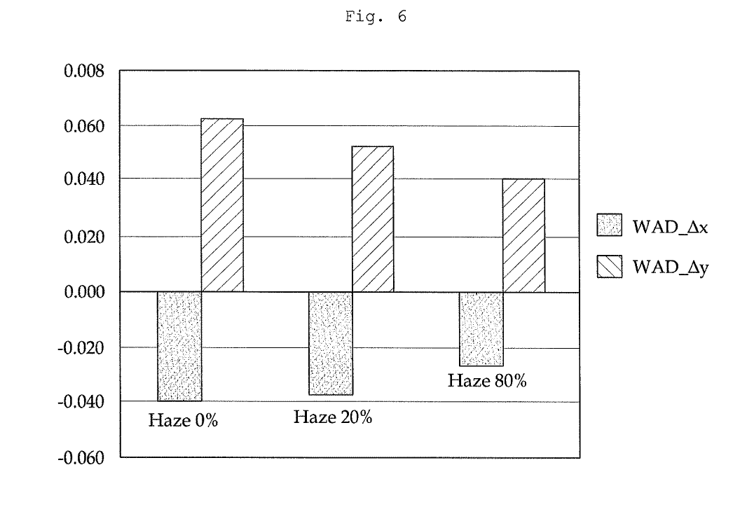

Hereinafter, light-extraction efficiency and probability of color difference depending on the content of bead particles 610 based on the total weight of the bead coating layer 600 will be described with reference to FIGS. 5 and 6.

FIG. 5 is a graph illustrating light-extraction efficiency depending on the content of bead particles 610 in the bead coating layer 600.

Referring to FIG. 5, light-extraction efficiency is illustrated with respect to three cases in which the content of bead particles based on the total weight of the bead coating layer is 0% (Comparative Example), the content of bead particles is 20% (Example 1) and the content of bead particles is 80% (Example 2).

As illustrated in FIG. 5, it will be appreciated from the bar graphs showing light-extraction efficiencies of white, red, green and blue light that the light extraction efficiencies increase in the order of Comparative Example, Example 1 and Example 2. It will be appreciated that light-extraction efficiency increases in proportion to the increase in the content of bead particles.

FIG. 6 is a graph illustrating probability of color difference (White Angular Dependence (WAD)) depending on the content of bead particles 610 in the bead coating layer.

Referring to FIG. 6, probability of color difference is illustrated with respect to three cases in which the content of bead particles based on the total weight of the bead coating layer is 0% (haze value is 0%; Comparative Example), the content of bead particles is 20% (haze value is 20%; Example 1), and the content of bead particles is 80% (haze value is 80%; Example 2). In FIG. 6, the probability of color difference at an angle of 60° deflected from the front is illustrated as a numerical value.

As illustrated in FIG. 6, it will be appreciated that color difference is reduced in the order of the haze value of 0%, the haze value of 20% and the haze value of 80%. That is to say, it will be appreciated that color difference is reduced in proportion to increase in the content of bead particles.

Based on the above-described results, it can be confirmed that providing the organic light emitting display device with the bead coating layer according to the embodiment can enhance luminous efficiency and visibility with reduced probability of color difference.

By way of summation and review, in the case of an organic light-emitting diode, enhancing low efficiency thereof may involve establishing internal resonance environment. However, an internal resonance environment may cause light in the front of the organic light-emitting diode to travel different paths and consequently, may give rise to different red, green and blue light efficiency ratios. The difference in light efficiency ratios may result in the occurrence of color differences depending on the viewing angle in the front and the side of the organic light-emitting diode. Moreover, due to light loss caused when a considerable portion of light emitted from the organic light-emitting layer is guided in a direction parallel to a stacking plane by total reflection, the organic light-emitting diode may have low light-extraction efficiency. Light-extraction efficiency refers to a ratio of the quantity of light extracted from the diode to a viewer to the quantity of light emitted from the light-emitting layer. An organic light-emitting diode having a low light-extraction efficiency has room for improvement in terms of characteristics of a display device, such as brightness, etc.

The present embodiments advance the art by providing an organic light-emitting display device and method of manufacture such that light from the organic light-emitting layer may be effectively extracted so as to achieve enhanced luminous efficiency and visibility with reduced color difference to enhance performance of the organic light-emitting diode display device. The organic light emitting display device includes a bead coating layer to restrict total reflection, achieving enhance luminous efficiency and visibility with reduced color difference depending on view angle.

Although the exemplary embodiments have been described for illustrative purposes, those skilled in the art will appreciate that various modifications, additions and substitutions are possible, without departing from the scope and spirit of the invention as disclosed in the accompanying claims.

What is claimed is:

1. An organic light-emitting display device, comprising:
a substrate;
a first electrode on the substrate;
an organic layer on the first electrode, the organic layer including a light-emitting layer;
a second electrode on an opposite side of the organic layer from the first electrode;
a protective layer on the second electrode;
a window member spaced apart from the protective layer such that the first electrode, the organic layer, the second electrode, and the protective layer are between the window member and the substrate; and
a bead coating layer between the protective layer and the window member.

2. The device as claimed in claim 1, wherein the bead coating layer is on a surface of the protective layer facing the window member, at a distance from the window member.

3. The device as claimed in claim 1, wherein the bead coating layer is located on a surface of the window member facing the protective layer, at a distance from the protective layer.

4. The device as claimed in claim 1, wherein the window member is glass.

5. The device as claimed in claim 1, wherein the window member and the substrate are sealed by a seal.

6. The device as claimed in claim 1, wherein the bead coating layer includes bead particles distributed in an organic matrix.

7. The device as claimed in claim 6, wherein a content of the bead particles is in a range of 50 to 80 wt % based on a total weight of the bead coating layer.

8. The device as claimed in claim 6, wherein a content of the organic matrix is in a range of 20 to 50 wt % based on a total weight of the bead coating layer.

9. The device as claimed in claim 1, wherein a thickness of the bead coating layer is in a range of 10 μm to 30 μm.

10. The device as claimed in claim 6, wherein an average diameter of the bead particles is in a range of 100 nm to 5 μm.

11. The device as claimed in claim 6, wherein the bead particles are selected from silica-based particles, zirconium-based particles and zirconium oxide particles.

12. A method of manufacturing an organic light-emitting display device, the method comprising:
forming a first electrode on a substrate;
forming an organic layer including a light-emitting layer on the first electrode;
forming a second electrode on the organic layer;
forming a protective layer on the second electrode;
forming a bead coating layer on the top of the protective layer; and
providing a window member such that the first electrode, the organic layer, the second electrode, and the protective layer are between the window member and the substrate.

13. A method of manufacturing an organic light-emitting display device, the method comprising:
forming a first electrode on a substrate;
forming an organic layer including a light-emitting layer on the first electrode;
forming a second electrode on the organic layer;
forming a protective layer on the second electrode;
forming a bead coating layer on a surface of a window member, and
arranging the window member such that the first electrode, the organic layer, the second electrode, and the protective layer are between the window member and the substrate and such that the surface of the window member on which the bead coating layer is formed faces the protective layer; and
sealing the window member

14. The method as claimed in claim 12, wherein the window member is glass.

15. The method as claimed in claim 12, wherein the window member and the substrate are sealed to each other by a seal formed along an edge of the window member.

16. The method as claimed in claim 12, wherein the bead coating layer includes bead particles distributed in an organic matrix.

17. The method as claimed in claim 16, wherein a content of the bead particles is in a range of 50 to 80 wt % based on a total weight of the bead coating layer.

18. The method as claimed in claim 16, wherein a content of the organic matrix is in a range of 20 to 50 wt % based on a total weight of the bead coating layer.

19. The method as claimed in claim 12, wherein a thickness of the bead coating layer is in a range of 10 μm to 30 μm.

20. The method as claimed in claim 12, wherein the bead coating layer is formed by applying and hardening a polymer syrup containing the bead particles.

21. The method as claimed in claim 20, wherein the polymer syrup containing the bead particles includes a light curable polymer and the bead particles.

22. The method as claimed in claim 21, wherein the light curable polymer is an acryl-based polymer resin.

23. The method as claimed in claim 20, wherein an average diameter of the bead particles is in a range of 100 nm to 5 μm.

24. The method as claimed in claim 20, wherein the bead particles are selected from silica-based particles, zirconium-based particles, and zirconium oxide particles.
